(19) United States
(12) Patent Application Publication
(10) Pub. No.: US 2008/0167997 A1
(43) Pub. Date: Jul. 10, 2008

(54) System and method for business or personal transactions

(76) Inventor: Alf Marcussen, (US)

Correspondence Address: David E. Orr, 4616 NE 134TH Street, Vancouver, WA, 98686, US

(21) Appl. No.: 11/650,095

(22) Filed: Jan. 4, 2007

(51) Int. Cl. G06Q 30/00

(52) U.S. Cl. 705/80

(57) ABSTRACT

A system and method for creating a business transaction, wherein certain information related to the transaction are recorded on a business card having two parts. A first entity initiating the transaction records an offer or commitment on the first card part, the first card part identifying the first entity, and gives the first card part to a second entity. Information related to the second entity is recorded on the second card part, which is retained by the first entity. The second entity may, later, present the first card part and complete the transaction. Information recorded on the first card part or the second card part may be made in machine-readable form, and may be later captured and stored in a database.

### FIELD

The present invention relates to methods for transacting business; more specifically the present invention relates to a system and method for initiating and consummating a transaction, wherein the media recording the transaction is a modifiable business card.

### BACKGROUND

The most important business transactions involve a personal encounter or meeting between a potential customer, or a customer and a businessman or businesswoman. During this encounter, the businessperson informs and offers the customer a product or service. During the discussion with the prospect or customer, the businessperson learns more about the prospect and his or her needs or desires. From this discussion, a astute business person is able to discern the prospects specific interests in the product or service to be offered. Due to the dynamic nature of the transaction and the variability of the offer made, the businessperson has neither sales collateral nor a quote or proposal to give the customer delineating the offer made and the response to the offer by the customer.

Therefore, what is needed is a mechanism for facilitating these types of dynamic business interactions wherein the businessperson may make, and record an offer to a prospect, and obtain information from the prospect and, at the same time provide the prospect with a receipt of the offer made, or to provide a prospect or customer with a coupon that may be redeemed later.

### SUMMARY

In a first aspect of the invention, a system and method utilizing a two-part business card, wherein the first part of the card records a commitment made by a first person to a second person, and the second part of the card records information related to the second person, wherein the first person retains the second card part and the second person retains the first card part.

In a variant of the first aspect, the second card part may also record the commitment made.

In the first aspect and its variant, the first person records the commitment.

In the first aspect and its variant, the recording made on the second card part may be made by either the first person or the second person.

In the first aspect and its variant, the recordings may be made in a machine-readable form and information may be read from either the first card part or the second card part, after which the information is stored in a database.

In a second aspect of the invention, a system and method utilizing a two-part business card, wherein the first part of the card records an offer made by a first person to a second person, and the second part of the card records information related to the second person, the information identifying the second person, wherein the first person retains the second card part and the second person retains the first card part. The second person presents the first card part to accept the offer made by the first person.

In a variant of the second aspect, the second card part may also record the offer made.

In the second aspect and its variant, the first person records the commitment.

In the second aspect and its variant, the recording made on the second card part may be made by either the first person or the second person.

In the second aspect and its variant, the recordings may be made in a machine-readable form and information may be read from either the first card part or the second card part, after which the information is stored in a database.

### OBJECTS AND ADVANTAGES

Different aspects of the invention with variants will be seen to have several objects with attendant advantages, the first being a system and method that utilizes an inexpensive business card as a means of recording a transaction between a first entity and a second entity.

A second object and advantage is a method of making and recording an offer during a meeting, the offer made from a first entity to a second entity, wherein the particulars of the offer are recorded at the time of the meeting on part of a business card.

A third object and advantage of the system and method is the offer may be accepted by the second entity presenting the business card part where the offer is recorded.

And yet another object is an object for recording that may serve as a business card or that may serve as a coupon.

And yet another object and advantage of the invention is a system and method of recording a business transaction on a business card wherein the recording may be machine readable.

Other benefits and advantages of the invention will appear from the disclosure to follow. In the disclosure reference is made to the accompanying drawings, which form a part hereof and in which is shown by way of illustration by exemplary embodiment in which the invention may be practiced. These exemplary embodiments will be described in sufficient detail to enable those skilled in the art to practice the invention, and it is to be understood that other embodiments may be utilized and that structural changes may be made in details of the embodiments without departing from the scope of the invention.

### BRIEF DESCRIPTION OF DRAWINGS

Labeling notation used in the drawings

In the drawing FIGS. 1, 2, 3, 4A, 4B and 5, elements of the multi-part card are labeled with a four digit number of the form “Deee”, where “D” denotes the drawing or figure number and “eee” is a label given the element. The element label “eee” is further specified as “e₁ e₂ e₃”, where e₁ is either “1” or “2”, with “1” designating the first part of the card and “2” denoting the second part of the card. e₂ can have a value of “1” denoting the front of a card part and a value of “2” denoting the back of a card part. e₃ further specifies a feature of either a front or back of a card part, depending on the value of e₂. For example, the label “3120” specifies in FIG. 3, the back of the first card part.

FIG. 1 shows an example of a card that may be used by a lawyer and the lawyer's client.

FIG. 2 is an example of a card used by a therapist.

FIG. 3 is an example of a card used by a chocolate purveyor.

FIGS. 4A and 4B are cards that may be used in real estate transactions.

FIG. 5 shows a card used in event promotion.

FIG. 6 shows an exemplary computing environment wherein information may be stored.

### DETAILED DESCRIPTION

With reference to the included drawings, a system and method of using a business card having two parts for recording information related to an offer made by a first entity to a second entity. The offer is made when the first entity records information related to the offer on the first card part, which contains information related to the first entity. Information related to the second entity is recorded on the second card part and is retained by the first entity. Later, the second entity may accept the offer or complete the transaction initiated by the offer by presenting the first card.

Information recorded on either card part may be machine-readable and my later be scanned and stored in a database. Information may be recorded, in part beforehand. Information may be hand-printed on the card in preset locations or may be hand-printed using a coding.

The offer made by the first entity may be for a product or service. A service offered may include entertainment.

Information recorded on the card may serve as a receipt for a transaction or may serve as a redeemable coupon.

The system and method will be illustrated by several exemplary embodiments, which now follow.

### System and Method Used by a Lawyer

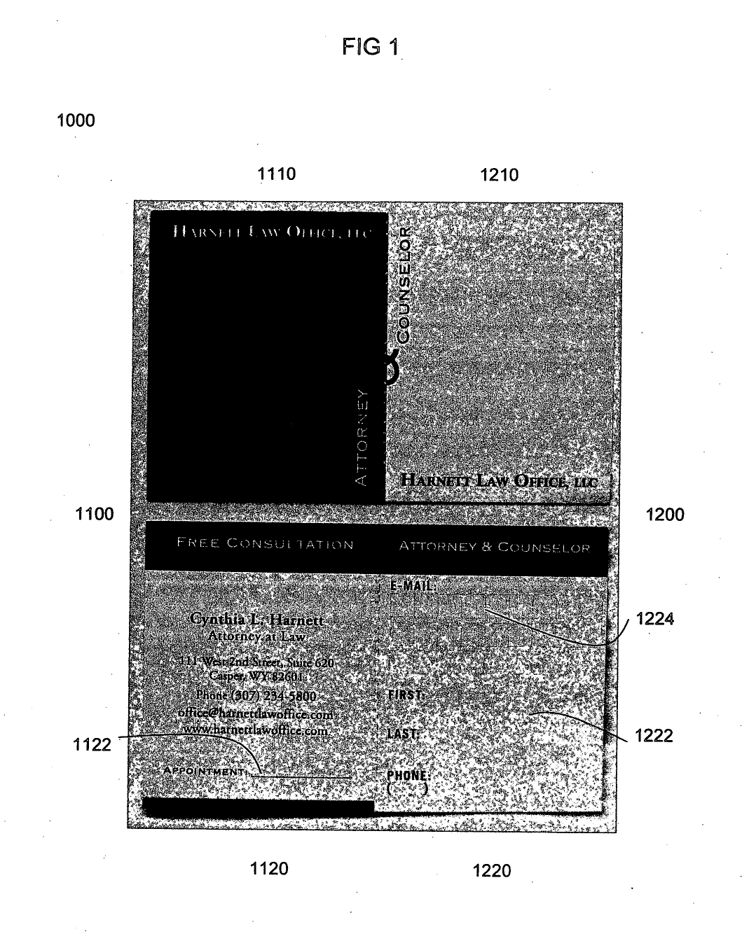

With reference to FIG. 1, a two-part card 1000 having a first part 1100 and a second part 1200. The first part 1100 has a front side 1110 and a backside 1120. The second part 1200 also has a front side 1210 and a backside 1220.

The lawyer negotiates a meeting or appointment with a prospect or client, and records information 1122, such as the appointment time, on the backside 1120 of the first part 1100 and gives the first part 1100 to the client.

The client or the lawyer records information such as name 1222 and E-mail address 1224 on the backside of the second part 1200, which is retained by the lawyer.

As a result of the transaction, the lawyer now has valuable client information and the client has a recording of the offer (appointment or time allocated).

Information recorded 1122, 1222 and 1224 may be scanned and stored in a computer system.

### System and Method Used by a Therapist

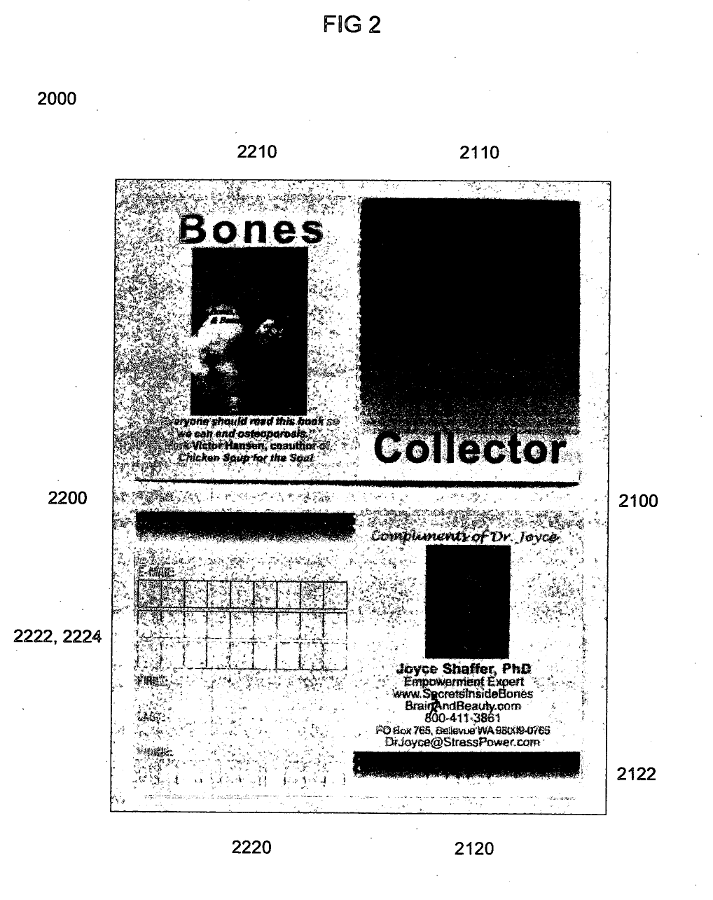

With reference to FIG. 2, a two-part card 2000 having a first part 2100 and a second part 2200. The first part 2100 has a front side 2110 and a backside 2120. The second part 2200 also has a front side 2210 and a backside 2220.

The therapist offers a free session to a prospect or client, and records information 2122, such as the free offer on the backside 2120 of the first part 2100 and gives the first part 1100 to the client.

The client records information such as name 2222 and E-mail address 2224 on the backside of the second part 2200, which is retained by the therapist.

As a result of the transaction, the therapist now has valuable client information and the client has a recording of the offer (free therapy session).

Information recorded 2122, 2222 and 2224 may be scanned and stored in a computer system.

### System and Method Used by a Chocolatier

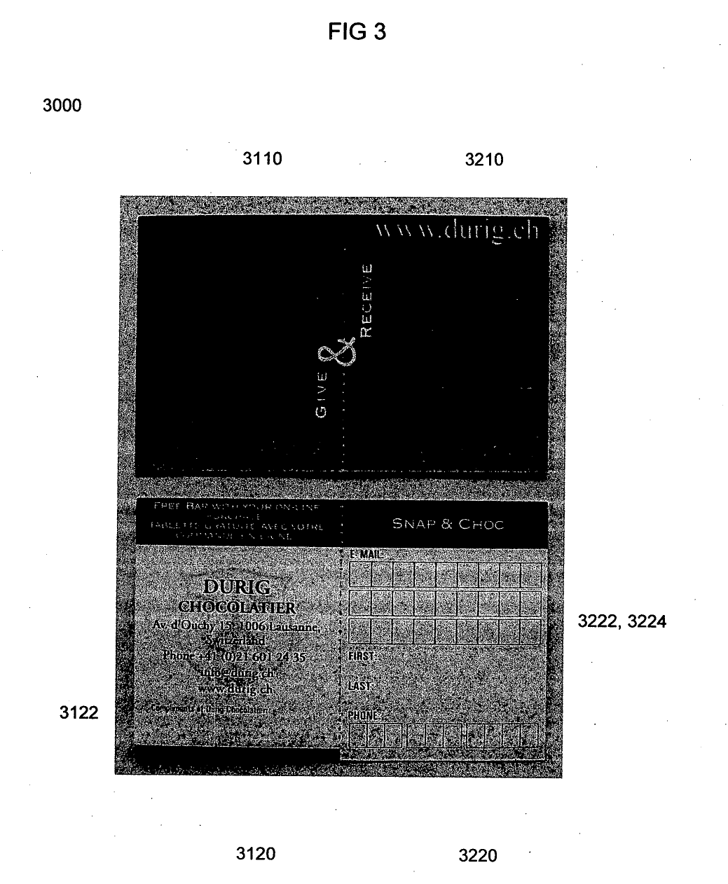

With reference to FIG. 3, a two-part card 3000 having a first part 3100 and a second part 3200. The first part 3100 has a front side 3110 and a backside 3120. The second part 3200 also has a front side 3210 and a backside 3220.

The choclatier offers a free samples to a prospective buyer, and records information 3122, such as the free offer on the backside 3120 of the first part 3100 and gives the first part 3100 to the prospect.

The prospect records information such as name 3222 and E-mail address 3224 on the backside of the second part 3200, which is retained by the chocolatier.

As a result of the transaction, the choclatier now has valuable prospect information and the prospect has a recording of the offer (free chocolates).

Information recorded 3122, 3222 and 3224 may be scanned and stored in a computer system.

### System and Method Used by a Real-Estate Person

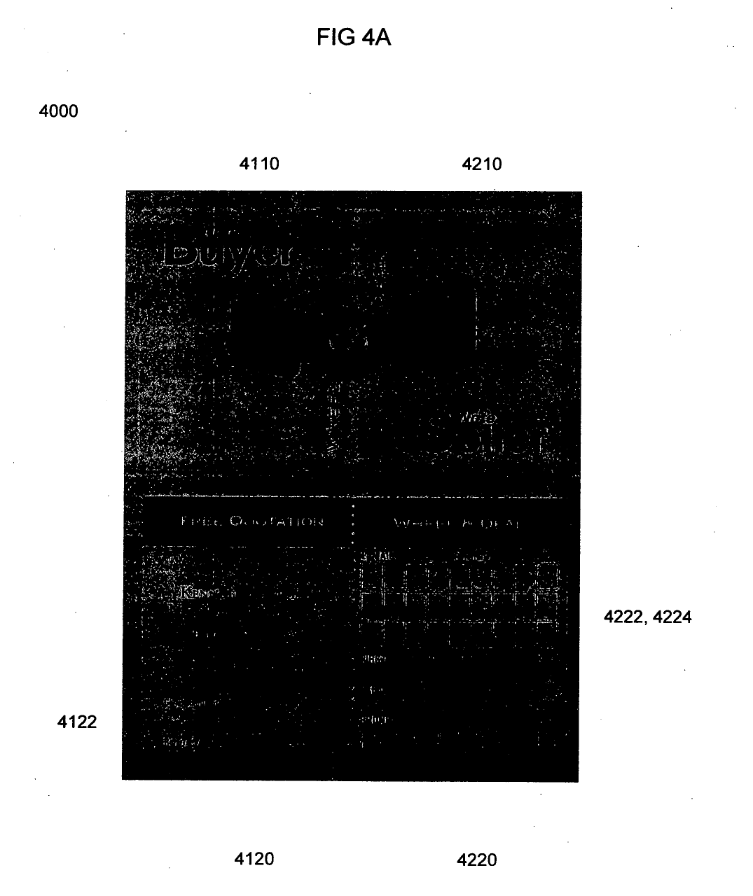

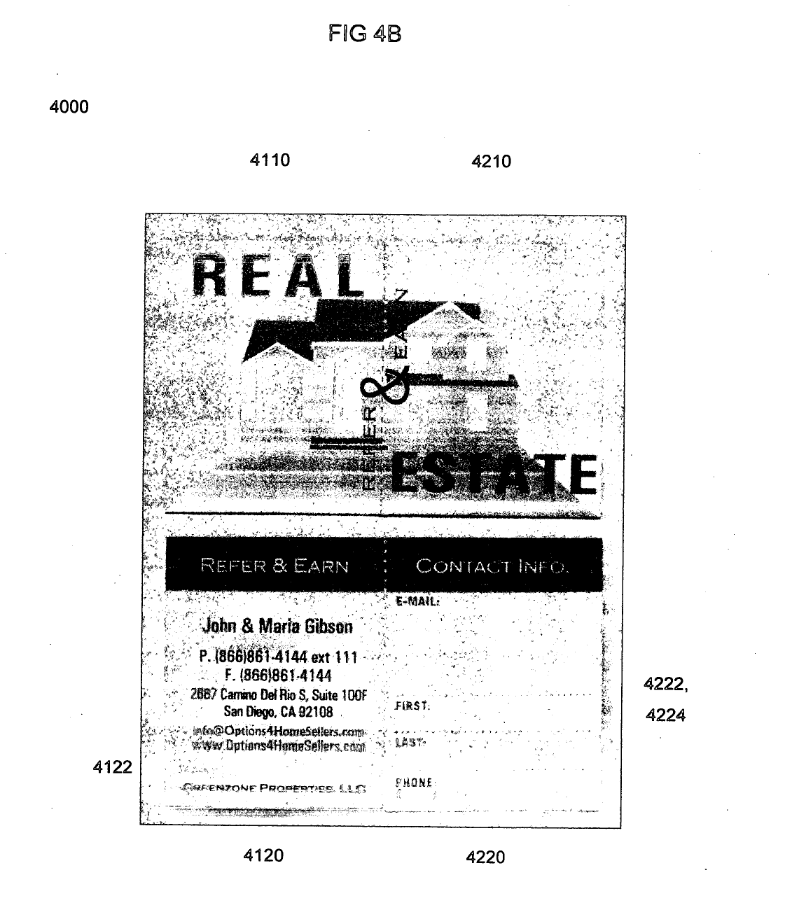

With reference to FIGS. 4A, and 4B a two-part card 4000 having a first part 4100 and a second part 4200. The first part 4100 has a front side 4110 and a backside 4120. The second part 4200 also has a front side 4210 and a backside 4220.

With reference to FIG. 4A, the real estate agent offers a free quotation to a prospective seller, and records information 4122, such as the free offer on the backside 4120 of the first part 4100 and gives the first part 4100 to the prospect.

The prospect records information such as name 4222 and E-mail address 4224 on the backside of the second part 4200, which is retained by the real estate agent.

With reference to FIG. 4B, the real estate agent offers a commission for a referral to a prospect, and records information 4122, such as the referral offer on the backside 4120 of the first part 4100 and gives the first part 4100 to the prospect.

The prospect records information such as name 4222 and E-mail address 4224 on the backside of the second part 4200, which is retained by the real estate agent.

### System and Method Used for Event Promotion

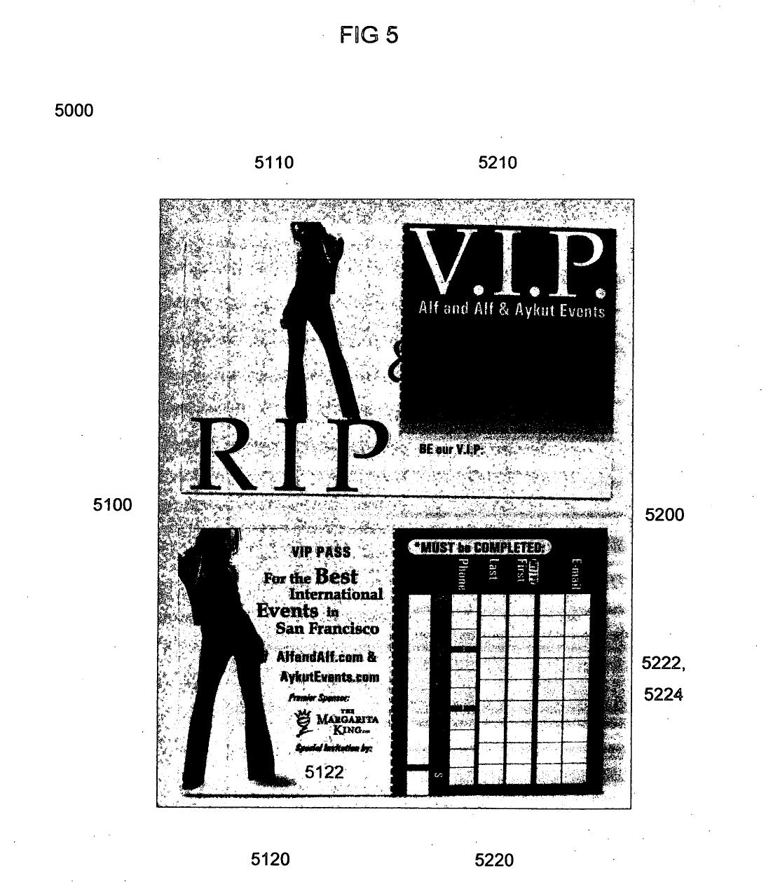

With reference to FIG. 5 a two-part card 5000 having a first part 5100 and a second part 5200. The first part 5100 has a front side 5110 and a backside 5120. The second part 5200 also has a front side 5210 and a backside 5220.

With reference to FIG. 5, an event promoter offers free attendance to a prospect, and records information 5122, such as the free offer on the backside 5120 of the first part 5100 and gives the first part 5100 to the prospect.

The prospect records information such as name 5222 and E-mail address 5224 on the backside of the second part 5200, which is retained by the promoter.

### Another Aspect of the Invention

With reference to any of FIGS. 1, 2, 3, 4A, 4B and 5, another aspect of the invention comprises a business card configured as recordable media, and that is physically divisible into at least two parts, wherein information is recorded on the first part by a first party, and given to a second party, the information recorded related to a business or personal transaction with a second party. Information is recorded on the second part by either the first party or the second party and is retained by the first party.

The second party may later present the first part of the recordable media to complete or consummate the transaction, or the second party may give the first part of the recordable media to a third party, and may complete or consummate the transaction by doing so (for example, the second party may derive benefit from the first party by the act of referral of the first party to the third party.)

The recordable card may be stocked and dispensed at a retail outlet, store or shop such as a Starbuck's™ coffee shop, where it may be acquired by the first party transacting with the second party. In this example, the merchant would provide the card free to its customers, or optionally a store may sell it.

Information recorded by the first party may relate to an offer made to the second party. The second party responds to the offer by presenting the first part of the media.

Information recorded on the first part or the second part may be machine-readable and may be scanned and stored in a database.

### An Additional Aspect of the Invention

With reference to any of FIGS. 1, 2, 3, 4A, 4B and 5, an additional aspect of the invention comprises a business card configured as recordable media, and that is physically divisible into at least two parts, wherein the first part serves as a traditional business card and is given by a first party to a second party. Information is recorded on the second part by either the first party or the second party and is retained by the first party. In this manner the second part serves as a business card for the second party.

### Computing Environment

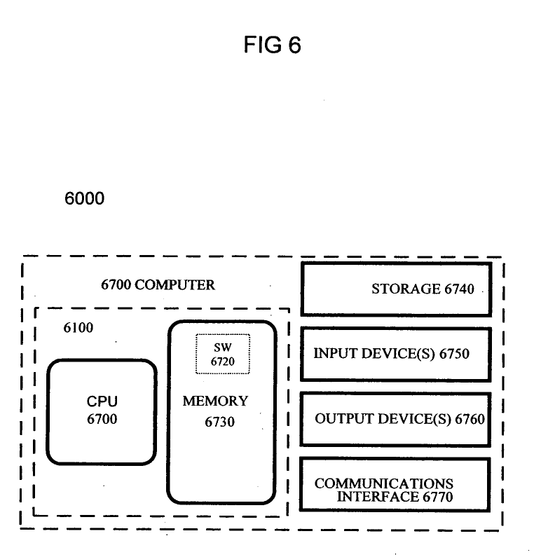

With reference to FIG. 6, scanning and storing of information may be implemented; for example, within a computing environment 6000, which includes at least one processing unit 6700 and memory 6730. In FIG. 6, this most basic configuration 6000 is included within a dashed line. The processing unit 6700 executes computer-executable instructions and may be a real or a virtual processor. In a multi-processing system, multiple processing units execute computer-executable instructions to increase processing power. The memory 6730 may be volatile memory (e.g., registers, cache, RAM), non-volatile memory (e.g., ROM, EEPROM, flash memory, etc.), or some combination of the two. The memory 6730 stores executable software—instructions and data 6250—written and operative to execute and implement the software applications required for an interactive environment supporting practice of the invention.

The computing environment may have additional features. For example, the computing environment 6000 includes storage 6740, one or more input devices 6750, one or more output devices 6760, and one or more communication connections or interfaces 6770. An interconnection mechanism (not shown) such as a bus, controller, or network interconnects the components of the computing environment, for example with servo-mechanisms and sensor devices too sense and control metering pumps, and valves for storing and releasing constituents into and from mixers, and concrete plant dispensing equipment. Typically, operating system software (not shown) provides an operating environment for other software executing in the computing environment, and coordinates activities of the components of the computing environment.

The storage 6740 may be removable or non-removable, and includes magnetic disks, CD-ROMs, DVDs, or any other medium which can be used to store information and which can be accessed within the computing environment. For example, the storage may store name, address and other information related to an offer made or information pertaining to the person offered. The storage 6740 also stores instructions for the software 6720, and is configured, for example, to store signal processing algorithms, databases storing card information, database software systems, intermediate results and data generated from sensor inputs.

The input device(s) 6750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 6760 may be a display, printer, speaker, or another device that provides output from the computing environment.

The communication interface 6770 enable the operating system and software applications to exchange messages over a communication medium with the sensor device, and servo-mechanisms in various instantiations of the apparatus of the invention. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 6770 is used to communicate with other devices. For example, the interface 6770 may be attached to a network, such as the Internet, whereby the computing environment 6000 interchanges command, control and feedback signals with other computers, devices, and machinery.

### DISCLOSURE SUMMARY

A system and method for recording a business transaction using a modifiable business card has been disclosed. The system and method has been illustrated by several exemplary embodiments. While other embodiments are conceivable, the nature and scope of the invention are delineated by the claims that follow.

I claim:

1. A business method for promoting a product to a customer, the method comprising giving the customer a card, the card having a first half and a second half, wherein:
the first half has business information, and an offer made to the customer for the product, and;
the second half has information supplied by the customer;
whereby the customer retains the first half and the business retains the second half.

2. A business method for promoting a service to a customer, the method comprising giving the customer a card, the card having a first half and a second half, wherein:
the first half has business information, and an offer made to the customer for the service, and;
the second half has information supplied by the customer;
whereby the customer retains the first half and the business retains the second half.

3. A method for transacting business with a customer, wherein information related to the transaction is recorded on a card having two parts, the first part retained by the business and having information recorded by the customer, and the second part retained by the customer and having an offer recorded by the business.

4. A business method for obtaining information from a customer, the method comprising giving the customer a card having two parts, wherein the first part is retained by the business and has information recorded by the customer, and the second part is retained by the customer and has an offer recorded by the business.

5. A business method for making an exchange offered to a customer, the method comprising recording information related to the exchange on a card having two parts, wherein the first part is retained by the business and records information supplied by the customer, and the second part is retained by the customer and records the offer.

6. The method of claim 5, wherein the exchange is recorded in a database.

7. A method for recording a transaction between a business and a customer, the transaction is recorded on a two-part card wherein:
the business records the transaction initiation on the first card part, and;
the customer records the transaction completion on the second card part and gives the second card part to the business.

8. The recording method of claim 7, the method further including the recording of information from the first card part in a database.

9. The recording method of claim 7, the method further including the recording of information from the second card part in a database.
